(19) United States
(12) Patent Application Publication
(10) Pub. No.: US 2007/0003910 A1
(43) Pub. Date: Jan. 4, 2007

(54) SIMULATION TOOL FOR MASS PRODUCTION OF CUSTOMIZED BIKES

(76) Inventor: Gene Kirila, Transfer, PA (US)

Correspondence Address: COHEN & GRIGSBY, P.C., 11 STANWIX STREET, 15TH FLOOR, PITTSBURGH, PA, 15222, US

(21) Appl. No.: 11/427,904

(22) Filed: Jun. 30, 2006

Related U.S. Application Data
(63) Continuation-in-part of application No. 11/171,529, filed on Jun. 30, 2005.

(51) Int. Cl. G09B 19/16

(52) U.S. Cl. 434/61

(57) ABSTRACT

The present invention is an adjustable simulation tool comprising a frame and a means for imparting a controllable simulation of ride characteristics to the frame. Activation of the simulation tool simulates the ride characteristics of the final configuration of a customized bike. The present invention is also a method of using the simulation tool to create a specification related to the rider's body and based on the simulation. The specification may be used to manufacture or sell a customized bike, accessories, or a combination thereof. In an embodiment, a plurality of biographical data about the rider is collected and may be used to customize the exterior of the customized bike. In an embodiment, rider may preselect the adjustment of at least one of the adjustable features prior to the simulation.

CROSS-REFERENCE TO RELATED APPLICATIONS

This application is a continuation-in-part of U.S. Nonprovisional application Ser. No. 11/171,529 filed on Jun. 30, 2005.

### FIELD OF THE INVENTION

The present invention relates generally to mass customized bikes, and more specifically to a simulation tool that simulates the final configuration of a customized bike. The present invention also relates to a method of using the simulation tool to create a specification that may be used to manufacture and sell customized bikes based on a combination of the rider's biomechanical measurements and the simulation.

### BACKGROUND OF THE INVENTION

Motorcycles that are mass-produced are not generally suitable or comfortable for all individuals, since each individual has a unique body shape and size. This can make it particularly difficult for individuals whose biomechanical measurements fall far outside of the normal ranges to purchase bikes that are comfortable for them. Manufacturers fail to account for the wide variety of body shapes and sizes that exist in the public, instead manufacturing bikes that are suitable for those individuals whose biomechanical measurements fall within the norm.

One industry that is particularly impacted by this mass-production standard is the motorcycle industry. Many individuals who desire to own and ride a motorcycle face limitations in the style of motorcycle that is comfortable for them to ride as a result of the individuals' physical attributes. Furthermore, existing methods for manufacturing customized motorcycles do not account for the biomechanical measurements of the rider. Such a consideration is particularly important to riders who have biomechanical measurements that differ from those of the average person. For example, women, race car drivers, and pro-athletes have biomechanical measurements that make it challenging for them to comfortably ride on and handle a motorcycle that is mass-produced. For example, a woman may like the look of a motorcycle with a rake that has a steep pitch to the fork, but may discover when she rides the motorcycle that the motorcycle has a lot of flop and therefore requires more strength to steer than she is able to sustain. Unfortunately, many of the manufacturers that claim to manufacture customized motorcycles tend to focus their customized market on catering to the rider's preference regarding the cosmetic appearance of the bike, while failing to account for each rider's individual biomechanical measurements prior to manufacturing the customized bike. Thus, these so-called “customized motorcycles” are not customized to the rider's body at all. Rather, they are customized only to the extent that the rider is able to select external or cosmetic features based on his/her unique preferences. As a result, the rider ends up paying a considerable amount of money for a bike that is not customized to meet his/her individual physical needs.

Additionally, existing methods of selling bikes, even so-called customized bikes, merely permit the rider to view and test-drive pre-manufactured bikes. This means that a rider is limited to test-driving whatever bikes a given dealer has on his/her sales lot, or which the dealer can access from the manufacturer or other dealers. Often, the bikes available for a test-drive do not offer the exact combination of features that the rider may end up selecting for his/her bike. This means that a rider may never experience the actual “feel” of riding the bike s/he purchases until after the purchase is completed and the bike is manufactured and delivered. This can result in considerable disappointment on the part of the rider, when, for example, the bike does not handle as expected or is too difficult for the rider to control.

A rider may be forced to compromise his/her selection of a bike by being forced to choose between two or more different models or styles of bike, each of which has some features that the rider finds attractive and others that the rider doesn't like as well, based for example, on appearance, style, comfort, or other factors.

Finally, in addition to motorcycles, the bicycle industry has many analogous problems. Principally, bike riders do not have the ability to customize their frame to meet their particular body size in a way that does not involve many compromises such as seat heights and handle bar placement. Unlike the motorcycle industry, customization for bicycles tends to be more fundamental than aesthetic.

### SUMMARY OF THE INVENTION

Thus, there is a need for a simulation tool that simulates the ride characteristics of a customized bike. There is also a need for a simulation tool that may be used to manufacture and sell a customized motorcycle as well bicycles while at the same time serving a mass market.

One example of an embodiment of the present invention is directed to a simulation tool that simulates the final configuration of a customized motorcycle or a bicycle. For example, with a motorcycle, the simulation tool is adjustable and comprises a frame and a means for imparting a controllable simulation of the ride characteristics to the frame and motor placement. The adjustability of the simulation tool allows the rider to select adjustments to the simulation tool so that the simulation tool and the customized bike created therefrom have the ride characteristics that the rider desires, such as for examples, vibration, harmonics, bounce, controllability, steerability, stiff to ride, or a combination thereof. The frame includes first and second wheel simulation points and an engine support means. When the simulation tool is activated, the means for imparting the simulation to the frame occurs through at least the first wheel simulation point. The frame also has first and second adjustable vertical members. The first adjustable vertical member is for positioning a seat means on the simulation tool and the second adjustable vertical member adjustably secures a steering means to the frame. First and second adjustable vertical members are each adjustable in both the vertical and horizontal planes. By adjusting these adjustable vertical members, the rider may adjust each of the seat means and the steering means vertically and horizontally to a preferred riding position that is both comfortable and that imparts the rider's desired ride characteristics. The frame preferably includes a first adjustable fork member connected to the second adjustable vertical member. The fork member is operatably connected to the steering means to simulate control at the first wheel simulation point. Adjustment of the fork member affects the amount of strength required by the rider to control the simulation tool so that the rider may select a preferred riding position. The frame has a first adjustable longitudinal member positioned between the first adjustable vertical member and the first adjustable fork member. The frame also has at least one pair of adjustable foot pods or pegs so that the rider may adjust the foot pegs to a preferred riding position. In another preferred embodiment, the simulation tool has additional points of adjustment.

In another example of an embodiment, the claimed simulation tool simulates the final configuration of a customized bicycle. The simulation tool comprises a frame and a means for imparting a controllable simulation of the ride characteristics to the frame so that the rider is able to select preferred adjustments to create the ride characteristics that the rider desires, as described above. The frame includes first and second wheel simulation points. Simulation is imparted as described above. The frame has first and second adjustable vertical members for positioning a seat means and a steering means, respectively. First and second adjustable members are adjustable in both the vertical and horizontal planes to enable the rider to adjust the seat means and the steering means to a preferred riding position. The frame preferably includes a first adjustable fork member connected to the second adjustable vertical member. Fork member is operatably connected to the steering means to simulate control at the first wheel simulation point. The frame has a first adjustable longitudinal member positioned between the first adjustable vertical member and the first adjustable fork member and at least one pair of adjustable foot pedals so that pedals may be adjusted to the rider's preferred riding position. As described above, the simulation tool may optionally be equipped with additional points of adjustment such as to compromise comfort with speed positioning of a body on a race bike or to provide greater power strokes on an off-road bicycle.

In examples, the means for simulating the ride preferably include motorized actuators, preferably step motors, controlled and activated by a computerized program synchronized with a visualization of a road or terrains.

In another embodiment of the present invention, a method of using the simulation tool to create a specification related to the rider's body is described. The specification is based on the simulation in combination with the rider's biomechanical measurements. The method of use comprises the step of collecting and recording at least one biomechanical measurement of the rider, such as physical measurements related directly to the body of the rider. The method of use also comprises the step of the rider selecting a simulation tool from a display of simulation tools. Each simulation tool of the display may simulate, for example, a different bike or may be differently adjustable. Alternatively, one such tool can be configured to a desired type of ride characteristic for the rider. The simulation tool is adjusted to a first suggested position based on the rider's biomechanical measurements. The rider is then positioned on the frame of the simulation tool and the simulation tool is activated to simulate the ride characteristics of the frame. Optionally, the rider may further adjust the simulation tool to fit his body or to obtain the desired ride characteristics. These steps may be performed in any order and optionally, at any time during the simulation, the rider may make further adjustments to the simulation tool to compare the simulation before and after the adjustments. Each simulation tool has a plurality of adjustable features and preferably at least the position of the rider's hands, seat, and feet are adjusted to create an optimally comfortable and/or preferred ride for the rider. The relationship between the position of the hands, seat, and feet is defined as a “comfort triangle” when they are positioned where the rider sits on the simulation tool with ultimate comfort. When the simulation yields the desired ride characteristics and the simulation tool is comfortable for the rider, the rider's preferred riding position for the simulation tool is recorded and then combined with the rider's biomechanical measurements to create a specification related to the body of the rider. This method of using the simulation tool to create a specification may be used to manufacture and/or sell customized bikes, at least one accessory, and/or a combination thereof. Optionally, the method of use may include a passenger.

In an embodiment, rider may optionally preselect at least one of the adjustable features prior to the simulation.

It is an object of the present invention to provide a simulation tool that is capable of simulating the performance of a customized bike.

It is another object of the present invention to provide a motorcycle that has a ride or feel that is customized to the rider's preferences.

It is another object of the present invention to provide a bicycle that has a ride or feel that is customized to the rider's preferences.

It is a further object of the present invention to provide an adjustable simulation tool.

It is a further object of the present invention to provide a simulation tool that is capable of simulating a variety of riding surfaces. It is still a further object of the present invention to provide a computerized method to control ride simulation of the frame with enviromnental visualization of a ride over various road types and weather.

It is yet a further object of the present invention to provide a method of using the simulation tool of the present invention to create a specification based on the simulation.

It is yet a further object of the present invention to provide a simulation tool that has a means for viewing an animated model of a rider positioned on the simulation tool to enable the rider to visualize him/herself on a customized bike.

It is another object of the present invention to provide a simulation tool that includes a means for capturing and displaying a real-time image of the rider on the simulation tool.

It is still a further object of the present invention to include a passenger in the simulation.

It is still a further object of the present invention to provide a rider with a bike that has a customized exterior.

It is still a further object of the present invention to provide a rider with a digital art library from which the rider can choose the cosmetic features of a customized bike.

It is yet a further object of the present invention to provide a rider with a digital art library that is inexpensive to apply to the customized bike.

It is yet a further object of the present invention to provide a method of using the simulation tool to manufacture and sell customized bikes.

It is still a further object of the present invention to provide a method of selling customized motorcycles whereby a dealer does not have to maintain an inventory of bikes.

It is yet another object of the method of using the simulation tool to optionally enable the rider to preselect certain adjustable features prior to using the simulation tool.

### BRIEF DESCRIPTION OF THE DRAWINGS

FIGS. 1A, 1B, 1C, and 1D show schematics of examples of embodiments of the simulation tool of the present invention.

FIG. 2 shows a schematic of an example of an embodiment of the frame used in the simulation tool of the present invention.

FIG. 3 shows a schematic of the method of using the simulation tool of the present invention to create a specification based on the simulation.

FIGS. 4A and 4B show schematics of examples of embodiments of the present invention.

FIG. 5 shows a schematic of the method of using the simulation tool of the present invention to sell to the public a customized bike.

FIG. 6 shows an example of a series of screenshots that a rider may optionally use to preselect certain adjustable features.

### DETAILED DESCRIPTION OF EXAMPLES OF EMBODIMENTS OF THE INVENTION

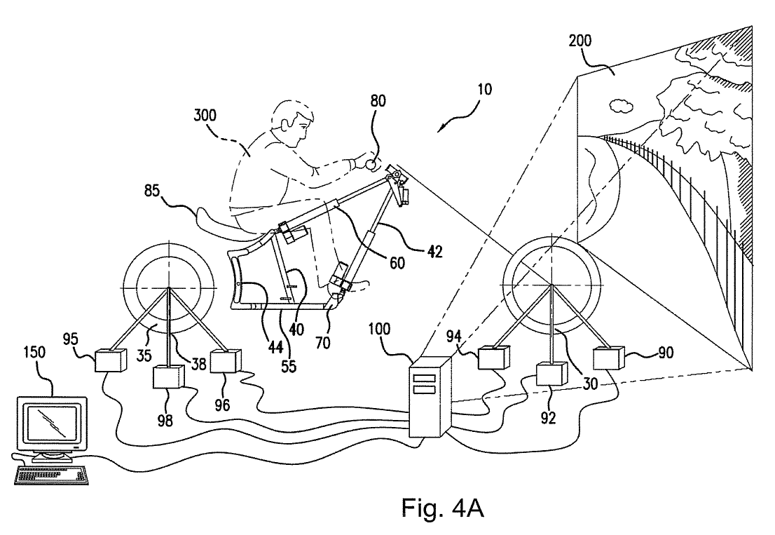

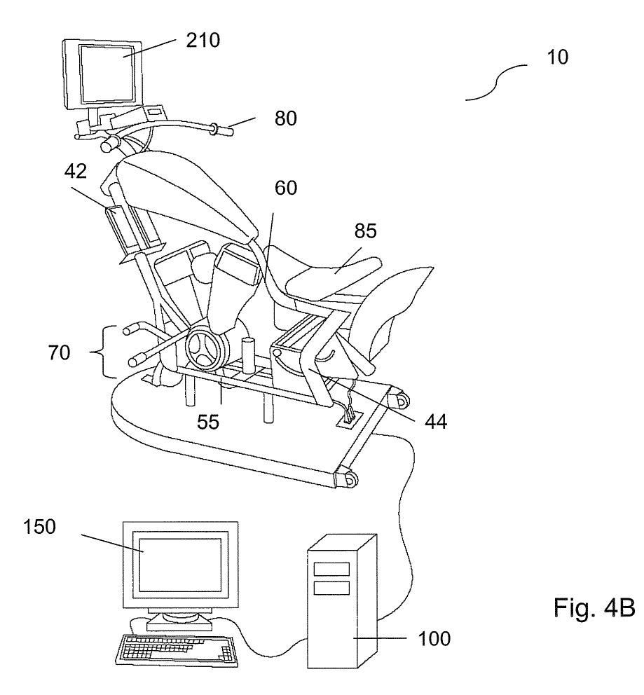

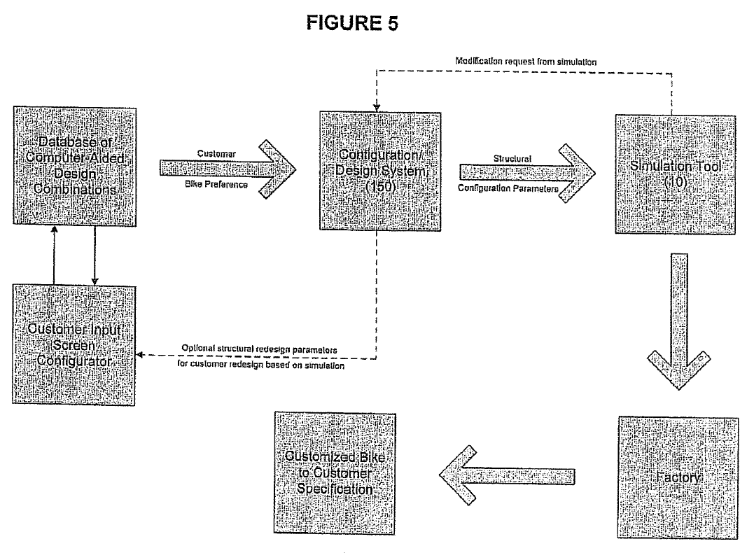

In an example of an embodiment, the simulation tool 10 of the present invention comprises a frame 20 that simulates at least one structural component of a bike and a means for imparting a controllable simulation of the ride characteristics to the frame 20. The means for imparting a simulation preferably include motorized actuators, preferably step motors 90, 92, 94, 95, 96, 98, controlled and activated by a computerized program 100 synchronized with a visualization, for example on a projection screen 200, of a road or terrain. See FIG. 4A. In another example, simulation tool 10 has a monitor 210 mounted thereon so that rider 300 can watch or view himself on the simulation tool in real time. See FIG. 4B.

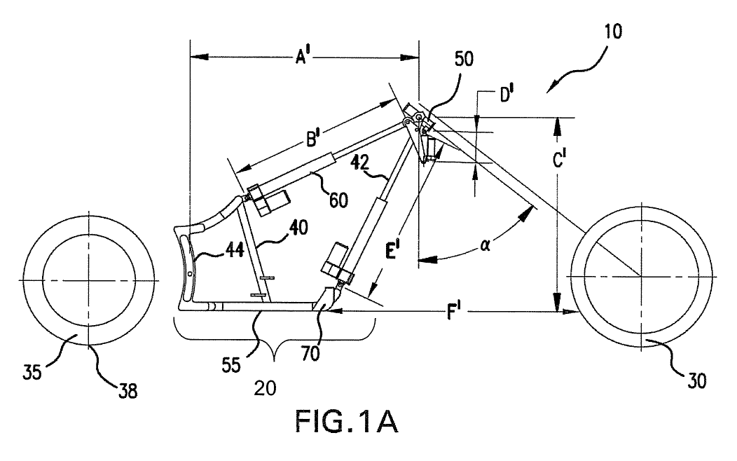

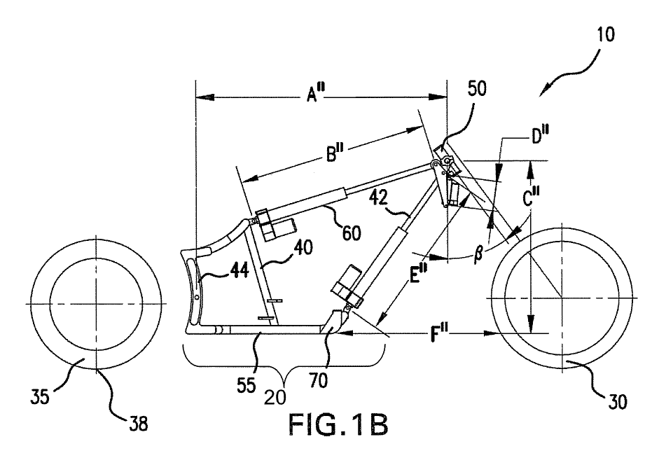

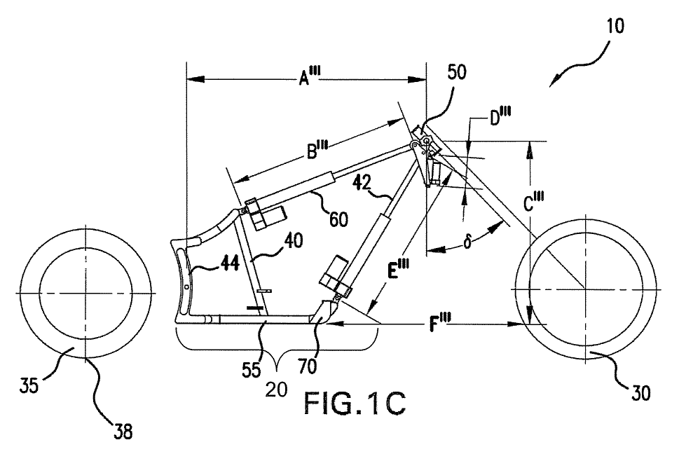

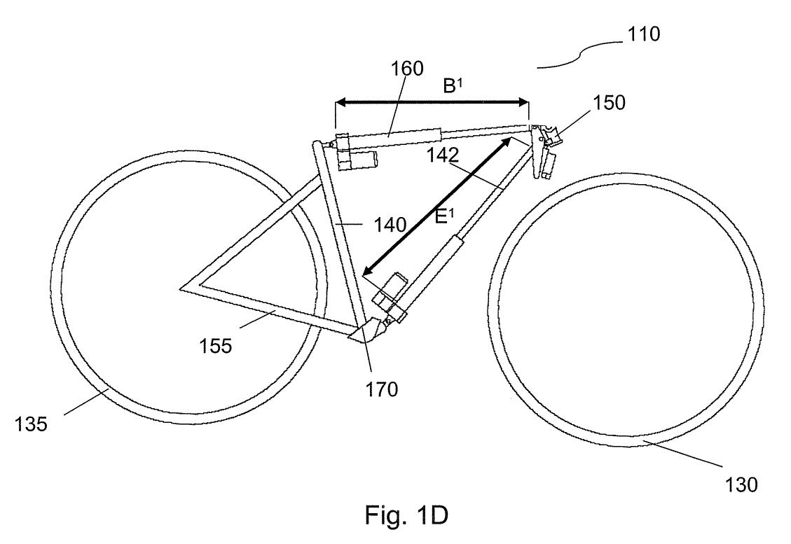

The simulation tool 10 of the present invention may be, for examples, any motorized bike, such as a motorcycle or a dirt bike, or any non-motorized bike such as a bicycle. The skilled artisan will appreciate, however, that there are other bikes that may be simulated using the present invention, and that this list is not intended to be limiting in any way. Schematics of examples of embodiments of the simulation tool 10 of the present invention in which the simulation tool 10 is a motorcycle are shown in FIGS. 1A-1C and a schematic of an example of an embodiment of the simulation tool 10 of the present invention in which the simulation tool 10 is a bicycle is shown in FIG. 1D. The simulation tools in Figures 1A-1C depict simulation tools having rake angles α (FIG. 1A), β (FIG. 1B), and δ (FIG. 1C).

In an embodiment, the frame 20 includes first and second wheel simulation points 30, 35. Optionally, the frame further includes an engine support means (not shown). The frame 20 has a first adjustable vertical member 40 for positioning a first seat means 85 that is adjustable in both the vertical and horizontal planes. First seat means 85 can be adjusted horizontally and/or vertically. A first adjustable fork member 50 is connected to a second adjustable vertical member 42 and is operatably related to the steering means 80. Second adjustable vertical member 42 is also adjustable in both the vertical and horizontal planes to enable steering means 80 to be adjusted horizontally and/or vertically. The first adjustable fork member 50 simulates control at the first wheel simulation point 30. There is a first adjustable longitudinal member 60 positioned between the first vertical member 40 and the first adjustable fork member 50. The frame 20 also includes at least one pair of first adjustable foot pegs 70.

Adjustment of the first adjustable fork member 50 determines the rake angle α, β, δ, measured from a point vertical to a centerline through the attachment point of first fork member 50 counterclockwise to a center of fork member 50. When first adjustable fork member 50 is adjusted so that angle α approaches 90° C., first wheel simulation point 30 extends from frame 20 a distance F′, as is shown in FIG. 1A. In contrast, when first adjustable fork member 50 is adjusted so that angle β approaches 0° C., first wheel simulation point 30 extends from frame 20 a distance F″, as is shown in FIG. 1B. When the first adjustable fork member 50 is adjusted to an angle δ, which is intermediate to angles α, β, first wheel simulation point 30 extends from frame 20 a distance F″′, as is shown in FIG. 1C. In FIGS. 1A-1C, angle α>δ>β and distance F′>F″′>F″.

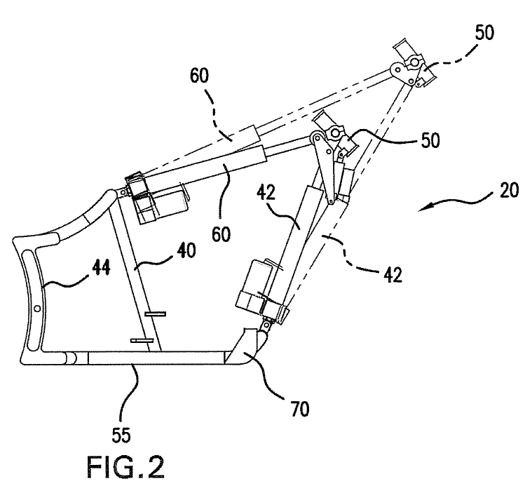

Angles α, β, δ affect the amount of flop that the simulation tool 10 has. As angle α approaches 90° C., first adjustable longitudinal member 60 and second adjustable vertical member 42 extend to lengths B′ and E′, respectively, as shown in FIG. 1A. Such an adjustment causes the rider 300 to experience a lot of “flop” (side to side movement of the fork assembly) in the steering means 80, making it difficult to keep the steering means 80 from moving from a first side to a second side. As angle β approaches 0° C., first adjustable longitudinal member 60 and second adjustable vertical member 42 retract to length B″ and E″, respectively, as shown in FIG. 1B, creating less flop and making the steering means 80 easier to control. Where angle δ is intermediate, first adjustable longitudinal member 60 and second adjustable vertical member 42 are adjusted to intermediate lengths B″′ and E″′ , respectively, as shown in FIG. 1C, creating an intermediate amount of flop. In FIGS. 1A-1C, B′>B″′>B″ and E″>E″′>E″. FIG. 2 further depicts the adjustability of first adjustable longitudinal member 60 and second adjustable vertical member 42, showing the adjustable members 42, 60 in the fully retracted position in solid line and in the fully extended position in shadow.

Angle α, β, δ also affects the “trail” of simulation tool 10, which is the position of the second wheel simulation point 35 of the simulation tool 10 in relation to the first wheel simulation point 30. On a simulation tool 10 having angle α approaching 90° C., second wheel simulation point 35 may be, for an example, within twenty-four inches (24″) of the first wheel simulation point 30. See FIG. 1A. On a simulation tool 10 having angle β approaching 0° C., second wheel simulation point 35 may be, for an example, within six to ten inches (6″ to 10″) inside of the position of the first wheel simulation point 30. See FIG. 1B.

FIGS. 1A-1C also show length A and heights C and D, all of which are adjustable based on adjustments made to frame 20. Length A′, A″, and A″′ measures the length of the frame 20 from back frame member 44 to steering means 80. Length A may be adjusted by extending or retracting first longitudinal member 60, for example. Height C measures a height of frame 20 relative to steering means 80 and is a substantially vertical distance between base member 55 and steering means 80. Height D measures a height of steering means 80.

As described above, the simulation tool 10 of the present invention is adjustable. Adjustment of the simulation tool 10 refers to an adjustment of at least one of the adjustable features on the simulation tool. In a preferred embodiment, adjustment of the simulation tool refers to adjustment of at least one of the first adjustable longitudinal member 60, first or second adjustable vertical members 40, 42, or first adjustable fork member 50. In a preferred example, at least the positions of seat means 85, steering means 80, and foot pegs 70 is adjustable. The adjustability of the simulation tool 10 allows the rider 300 to simulate and compare the angle α, β, δ, flop, and trail of the simulation tool 10 when the simulation tool 10 is differently adjusted so that the rider 300 may select a preferred riding position based on, for example, comfort and ability to control the simulation tool 10 (as is discussed below). In an embodiment, the simulation tool is spatially adjustable. In an example, the simulation tool is infinitely adjustable between first and second endpoints, such that the simulation tool may be adjusted to any point that exists between endpoints. In another example, the simulation tool is adjustable to at least one discrete point between endpoints. In yet another example, the simulation tool 10 is three-dimensionally adjustable relative to a predetermined point of origin 38. In FIGS. 1A-1C and 4, predetermined point of origin 38 is a point on a surface of second wheel simulation point 35. In an embodiment, simulation tools that are spatially adjustable comprise linear actuators that are electrically controlled so that the simulation tool extends and contracts as it is adjusted. In another embodiment, the simulation tool has a locking means such as a knob to secure the adjustments made to the simulation tool.

Adjustment, however, is not limited to spatial orientation, but may also include a variation in how the simulation tool 10 is constructed or the materials from which the simulation tool is constructed. For an example, the frame 20 of the simulation tool 10 may be adjustable in that the rider 300 may select from at least two frames, each frame being constructed of a different material, such as for example, aluminum, steel, fiberglass, titanium, or a combination thereof. In another example, the simulation tool may have an adjustable steering means 80. As described above, the steering means 80 may be three-dimensionally adjustable relative to a predetermined point of origin such that the position of the steering means 80 may be adjusted along the X, Y, and Z axes. Additionally, the adjustable steering means 80 may be adjusted from a steering means having a solid shaped rod to a steering means having a hollow shaped rod by physically interchanging the solid steering means for one that is hollow (not shown). This physical interchangeability allows the rider to experience the vibration created by each steering means. This adjustment may occur by interchanging the steering means one for another. In yet another example, the steering means may be adjustable both three-dimensionally and by physically interchanging the steering means.

In another example, the frame 20 may further include a first at least one pair of adjustably removable shock absorbers (not shown) positioned between the fork member 50 and the frame 20 and the other of the first at least one pair of shock absorbers and between the first vertical member 40 and the first seat means 85. In yet another example, the simulation tool may not have any shock absorbers, creating a hard tail ride, but may be adjusted to be equipped with shock absorbers to create an air ride, thus simulating the two ride characteristics and enabling the rider 300 to compare the ride characteristics with and without shock absorbers to select a preferred riding position of the shock absorbers (i.e., whether or not to ultimately equip the customized bike with shock absorbers). In another example, the frame 20 may be equipped with a first at least one model of shock absorbers that may be interchanged with a second at least one model of shock absorbers so that the rider 300 may interchange first and second models of shock absorbers and compare the ride characteristics of each model.

Finally, in yet another example of an embodiment of the invention, the simulation tool 10 may have an adjustable center of gravity (not shown). For an example, a rider 300 may select a simulation tool 10 that has a low center of gravity, which makes the bike feel lighter to the rider 300 and gives the bike less lean limits. The rider 300 may adjust the center of gravity to be higher to give the bike more lean limits. This enables the rider 300 to compare the different rides created by the adjustment and to select a preferred riding position of the center of gravity.

Optionally, in an embodiment, the simulation tool 10 may further comprise a means for imparting a simulation of a riding surface to the frame. In an example, the riding surface is adjustable so that the simulation tool 10 may simulate a variety of surfaces. The riding surface may include asphalt, concrete, pavement, dirt, rock, grass, mud, weeds, or a combination thereof. In another example, the simulation tool 10 simulates bumps in the riding surface. In embodiments, the adjustability of the riding surface allows the rider 300 to simulate the ride characteristics of bikes with and without shock absorbers to select a preferred riding position, or to compare the ride characteristics of frames having different types of shock absorbers to select a preferred riding position.

The means for imparting the simulations of the frame ride and the riding surface may be a computer controlled network operably connected to the frame. In an example of an embodiment, there are motorized actuators, preferably step motors 90, 92, 94, 95, 96, 98, controlled and activated by a computerized program 100 synchronized with a visualization, for example on a projection screen 200, of a road or terrain, as is shown in FIG. 4A. Preferably, step motors 90, 92, 94, 95, 96, 98 are connectedly attached to first and second wheel simulation points 30, 35 and impart motion to the frame 20 so that the rider 300 experiences the ride characteristics of the simulation tool 10, such as, for examples, vibration, harmonics, bounce, controllability, steerability, stiff to ride, or a combination thereof. Where the simulation tool 10 includes at least one riding surface, the actuators or motion devices impart motion to the frame 20 that simulates the selected riding surface so that the rider 300 can experience the ride characteristics of the simulation tool 10 on the riding surface.

The simulation tool 10 of the present invention may also optionally further comprise a means for viewing, such as on a projection screen 200, an animated model of the rider 300 positioned on the simulation tool. This allows the rider 300 to see what s/he will look like on a customized bike manufactured from the simulation. In an example of an embodiment, the means for viewing is a screen 200 that shows the rider 300 positioned on the frame 20 traveling on a road or terrain. See FIG. 4. In another example of an embodiment, the means for viewing is a digitized image that outlines the components of the body. Electronic data points are plotted as a digitized map to recreate the position of the rider 300 on the simulation tool so that the rider 300 can view the image on a computer screen.

In another example shown in FIG. 4B, the simulation tool 10 further comprises a monitor 210 mounted, for example, on steering means 80 that enables rider 300 to view himself on the simulation tool 10 in real time. Monitor 210 may be, for example, a flat screen monitor such as the one shown in FIG. 4B or any other viewing device. In an example, there is a capturing means (not shown) that captures rider's 300 image for display on monitor 210. The capturing means and monitor 210 enable the rider 300 to look directly at himself on the simulation tool 10 to see how he looks on a specific style of bike. In examples, there is a plurality of capturing means positioned to capture the image of the rider 300 from a variety of views, including front, rear, side, and top, for examples.

The simulation tool of the present invention may also optionally further include a computer controlled means for measuring or calculating from a fixed point any adjustment made to the frame 20. The means for measuring or calculating adjustment may be used to provide an output that may be used to design or manufacture a customized bike. An example of an output is the specification shown in Table 1, discussed below.

In an example of an embodiment, the claimed simulation tool 110 is a bicycle such as the one shown in FIG.1D. As described above, the simulation tool 110 comprises a frame 120 that simulates at least one structural component of a bicycle and a means for imparting a controllable simulation of the ride characteristics to frame 120. The frame 120 includes first and second wheel simulation points 130, 135. See FIG. 1D. Frame 120 has a first adjustable vertical member 140 for positioning a first seat means (not shown). A first adjustable fork member 150 is connected to second adjustable vertical member 142 and is operatably related to the steering means (not shown). First adjustable fork member 150 simulates control at the first wheel simulation point 130. First adjustable longitudinal member 160 is positioned between first vertical member 140 and first adjustable fork member 150. Frame 120 also includes at least one pair of first adjustable foot pegs or pedals 170. Adjustment of the simulation tool 110 and of adjustable members 140, 142, 150, 160, 170 is as described above.

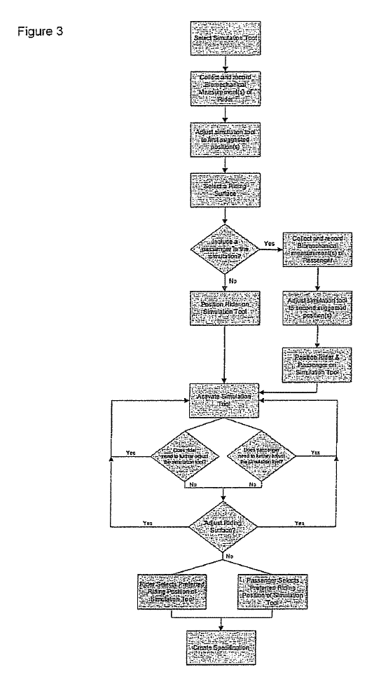

In another embodiment, the invention is a method of using one of the simulation tools described above to create a specification related to the body of the rider 300, the specification being based on the simulation. In an embodiment, the specification may be used to manufacture or sell a customized bike, at least one accessory, and/or a combination thereof. A schematic of the method of use of the present invention is depicted in FIG. 3.

The method of use comprises collecting and recording at least one biomechanical measurement of the rider. Such biomechanical measurements may include, for examples, the rider's height, weight, arm length, leg length, shoe size, arm strength, leg strength, hand strength, or a combination thereof. The skilled artisan will appreciate, however, that there is a plurality of biomechanical measurements that may be taken for a particular rider, and that this list is not intended to be limiting.

The biomechanical measurements may be collected and recorded by any means known to those skilled in the art. In an example, the biomechanical measurements may be made by scanning the rider's body and creating a model or virtual image of the rider's body by any method known to those skilled in the art of scanners to create a model of the rider's body. In an example of an embodiment, a digitized image that outlines the rider's body is created and from that digitized image electronic data points are plotted on a digitized map. From the digitized map, the at least one biomechanical measurement may be made. In another example, the biomechanical measurements may be collected using such devices as scales, measuring tapes, and/or weight machines or free weights, or a combination thereof. The measurements may be recorded by hand, electronically, digitally, or by a combination thereof. In yet another example, the collected and recorded biomechanical measurements and the body scan may be combined to create the virtual image.

The method of use also comprises the step of the rider selecting a simulation tool from a display of at least one simulation tool. See FIG. 3. The selected simulation tool has characteristics that the rider desires, such as physical appearance, physical attributes, speed, handling, and/or style. Where the bike simulator is a motorcycle, the rider may select a simulation tool in which the selected model of the bike simulator is one of those shown in FIGS. 1A-1C. Likewise, where the simulator is a bicycle, rider 300 may select a particular model of bicycle simulator from a variety of models, including mountain bicycles, racing bicycles, and road bicycles, for examples.

The method of use also comprises adjusting the selected simulation tool to a first suggested position based on the rider's biomechanical measurements. The first suggested position is an expected or anticipated preferred riding position that considers and combines the selected simulation tool, the rider's biomechanical measurements, and the ride characteristics that the rider desires from the simulation tool to arrive at the first suggested position. These considerations are not intended to be limiting, however, as the skilled artisan will appreciate that a plurality of considerations may go into determining the suggested position.

In an example, the seat means 85, foot pegs 70, and/or steering means 80 are adjusted so that the rider's leg extension, arm reach, and/or seating position are adjusted to determine the rider's personal preferred position. In a preferred example, leg extension, arm reach, and seating position are each adjusted. These three points define a “comfort triangle” that is used in the customization of the bike to ensure that the rider will sit comfortably on the bike by positioning feet, hands, arid seat for optimal riding comfort. In addition, with a bicycle, the comfort triangle also includes additional positioning for the petals to achieve optimized power strokes for hills and petal velocity for high speed racing.

Optionally, the method of using the simulation tool may comprise the step of selecting a riding surface from at least one available riding surface. In an embodiment, there are at least two riding surfaces so that the ride characteristics of the simulation tool on each riding surface may be simulated and compared by the rider.

Continuing through the steps shown in FIG. 3, the method of use also comprises positioning the rider on the simulation tool, such as by the rider assuming a riding position. For example, where the simulation tool is a motorcycle, the rider may position himself on the simulation tool by sitting on the seat means, grasping the steering means, and placing his feet on the foot pegs to simulate riding a motorcycle.

The method of use shown in FIG. 3 also comprises activating the simulation tool to simulate the ride characteristics of the simulation tool and of a customized bike manufactured therefrom. Activation of the simulation tool may be repeated at least two times so that the rider may further adjust the simulation tool and/or riding surface to optionally compare the ride characteristics of the simulation tool where the simulation tool and/or riding surface is differently adjusted.

The rider may optionally adjust the simulation tool from the suggested position. Although the example shown in FIG. 3 shows this step occurring after the simulation tool is activated, the rider may optionally adjust the simulation tool from the suggested position before the simulation tool is activated. Although FIG. 3 shows the above steps of the method of use in a particular order, this figure is intended to be an example only, and is not intended to be limiting in any way. The steps described so far may be performed in any order, and may optionally be repeated at least twice.

The method of use also comprises the rider selecting a preferred riding position. The preferred riding position is the adjustment of the simulation tool that simulates the rider's desired ride characteristics. The preferred riding position of the simulation tool will be defined by different criteria unique to each rider, but for examples may be based upon such considerations as comfort, controllability, amount of strength required to control the simulation tool, physical appearance, or a combination thereof. This list is not intended to be limiting, as other factors may also influence a rider's preferred riding position.

Referring again to FIG. 3, the preferred riding position of the simulation tool is recorded either manually, digitally, electronically, or by a combination thereof, and is included in the specification, which is created based on the simulation. The specification is related to the rider's body and details the rider's biomechanical measurements, the selected simulation tool, and the rider's preferred riding position of the simulation tool. The selected simulation tool and the rider's preferred riding position are used in combination with the rider's biomechanical measurements to create a customized bike for the rider. An example of a specification is shown in Table 1, discussed below. Optionally, the specification may be used to manufacture or sell, for examples, a customized bike, at least one accessory, or a combination thereof.

Referring still to FIG. 3, the method of using the simulation tool of the present invention may optionally include at least one passenger positioned on the simulation tool. Positioning at least one passenger on the simulation tool with the rider simulates how the presence of the passenger affects or alters the ride characteristics of the simulation tool, thereby enabling the rider to adjust the simulation tool to achieve the desired ride characteristics. Where a passenger is included, the biomechanical measurements of the passenger are collected and recorded as described above for the rider. In an example of an embodiment, the simulation tool is adjusted to a second suggested riding position based on the passenger's biomechanical measurements. The simulation tool is activated and the passenger may optionally select a preferred riding position, either before and/or after the simulation, as discussed above in regard to the rider. In an embodiment, the adjustment of the simulation tool to the passenger's suggested or preferred riding position is limited to features on the simulation tool that are related to the passenger's comfort while positioned on the simulation tool. For example, features related to the passenger's comfort may include at least one second pair of foot pegs, a grab means attached to the frame to provide a means for the passenger to steady himself or hold on to the frame of the simulation tool, a second adjustable seat means on which said passenger may be positioned, and/or a support means for providing support to the passenger's body.

Adjustment of these features of the simulation tool, however, is not limited to adjustment based on the passenger's preferred riding position. The rider may also adjust the simulation tool to adjust features that are generally related to the passenger's comfort.

For example, the rider may select a simulation tool that does not have a grab means or a support means.

In yet another example of an embodiment of the present invention, a plurality of biographical data about the rider is collected and may optionally be used to customize the exterior of the customized bike (not shown). For example, data such as the rider's profession, hobbies, interests, or a combination thereof may be used to customize the exterior of the customized bike. In an embodiment, there is a digital art library of commissioned and consigned artwork that the rider may view and select to customize the exterior of the customized bike. In examples, the artwork is applied to the exterior of the customized bike by an electronic means, by hand, or by a combination thereof. The benefit of the digital art library being applied by an electronic means is that it provides an inexpensive alternative to customizing the exterior of each customized bike.

In an example of an embodiment, the method of use of the present invention may include viewing a virtual image of the rider, and optionally the passenger, positioned on the customized bike that will ultimately be manufactured based on the specification created from the simulation (not shown). This virtual image will show what the customized bike will look like with the rider and optionally the passenger positioned thereon. In another example, the method of use inchldes viewing the rider in real-time on monitor 210, described above.

Optionally, the method of use of the present invention comprises further adjusting the simulation tool after the customized bike is manufactured or purchased (not shown). This further adjustability gives the rider the ability to maintain a customized bike despite changes that occur after the simulation, creation of the specification, and manufacture of the customized bike, such as for examples, changes in the rider's and/or passenger's weight or strength. Optionally, the adjustment after manufacture may include a passenger that was not included in the simulation prior to manufacture. The inclusion of a passenger may require the rider to adjust the simulation tool to a new preferred riding position to maintain the desired ride characteristics of the customized bike. Optionally, the passenger may be able to adjust the simulation tool after manufacture, as described above.

Table 1 shows an example of a specification created from the simulation. The specification may be created by hand, graphically, or by a combination thereof. In an example, the specification defines the selected simulation tool, the biomechanical measurements of the rider, and the rider's preferred riding position of the adjustable simulation tool. In the example shown, the preferred riding position of the steering means, first seat means, and first pair of foot pegs are defined by a set of numbers. Each set of numbers represents the position of each steering means, seat means, and foot pegs relative to a predetermined point of origin. In the example specification shown, each number corresponds to one of the X, Y, or Z axes, and represents a distance in inches from the predetermined point of origin, which in this example is a point on a first surface of the second wheel simulation point. Any point may be chosen as the point of origin, however.

As detailed in the example specification shown in Table 1, the first seat means is adjusted to a position that is five (5) inches from the point of origin along the X-axis, twelve (12) inches from the point of origin along the Y-axis, and zero (0) inches from the point of origin along the Z-axis. The steering means is adjusted to a position that is twenty (20) inches from the point of origin along the X-axis, seventeen (17) inches from the point of origin along the Y-axis, and twelve (12) inches from the point of origin along the Z-axis. Finally, Table 1 shows that the foot pegs are positioned twenty-five (25) inches from the point of origin along the X-axis, four (4) inches from the point of origin along the Y-axis, and four (4) inches from the point of origin along the Z-axis.

The example specification shown in Table 1 also indicates that the rider has selected an aluminum frame and a 90 HP engine. Details on angle α and lengths of adjustable features on the frame are also provided.

Finally, the specification provides the biographical data that were collected about the rider. In this example, the rider is a doctor whose hobbies include hunting and fishing. The rider has selected to customize the exterior of the customized bike by

TABLE 1
Example Specification Created From Simulation

| | | Simulation |
|---|---|---|
| Model Selected: | | Tool A |
| Biomechanical | Gender: | Male |
| Measurements: | Height: | 6′1″ |
| | Weight: | 215 lbs. |
| | Arm Length: | 30″ |
| | Leg Length: | 38″ |
| | Shoe Size: | 12 |
| | Arm Strength (bench press): | 240 lbs. |
| | Leg Strength (squats): | 500 lbs. |
| | Hand Strength (grip): | 150 lbs. |
| Preferred Position of | Frame Material: | Aluminum |
| Adjustable Features: | Engine Size: | 90 HP |
| | Angle α: | 52° |
| | First adjustable longitudinal | 32.75″ |
| | member (B′), Length: | |
| | Second adjustable vertical | 32.16″ |
| | member (E′), Length: | |
| | A′, Length | 42″ |
| | D′, height | 5.75″ |
| | C′, height | 36″ |
| | Steering Means: | Hollow |
| | Steering Means, Position From | 20″, 17″, 12″ |
| | Point of Origin (X, Y, Z): | |
| | First seat means, From Point of | 5″, 12″, 0″ |
| | Origin (X, Y, Z): | |
| | First adjustable foot peg, | 25″, 4″, 4″ |
| | Position | |
| | From Point of Origin (X, Y, Z): | |
| | Shock Absorbers: | No |
| Biographical Data: | Profession: | Doctor |
| | Hobbies: | Hunting, Fishing |
| Exterior: | Base Color: | Black |
| | Artwork Chosen: | Medical Symbol |
| | Application Means: | Electronic |

including a medical symbol electronically applied over the black base color of the customized bike.

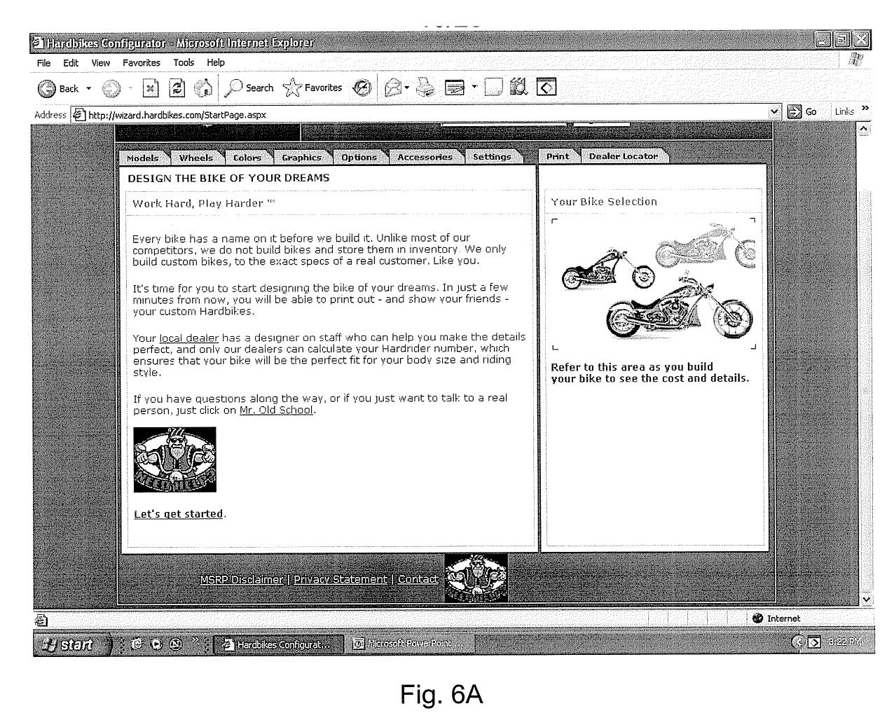

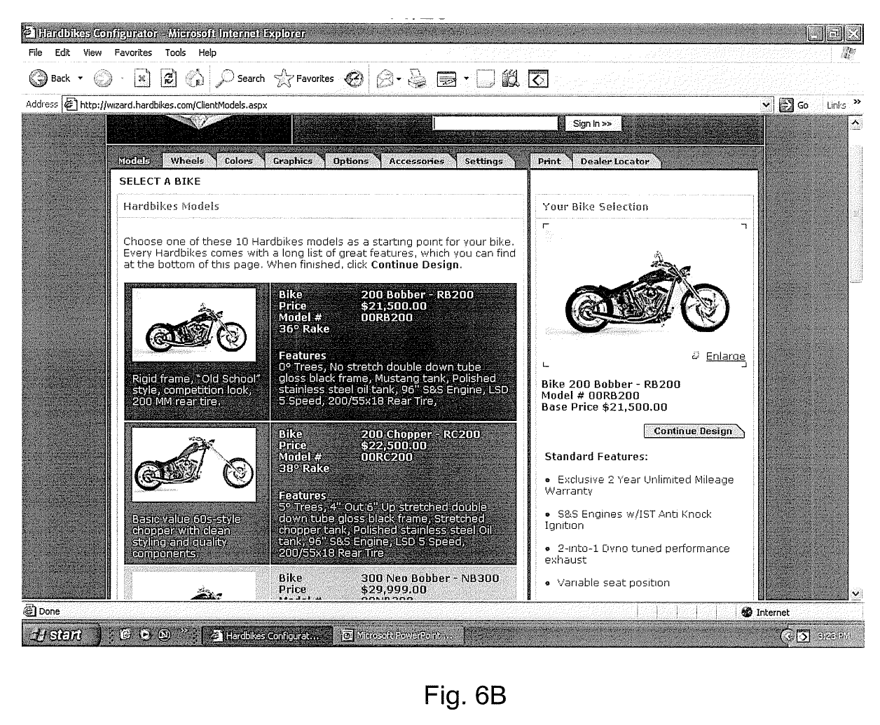

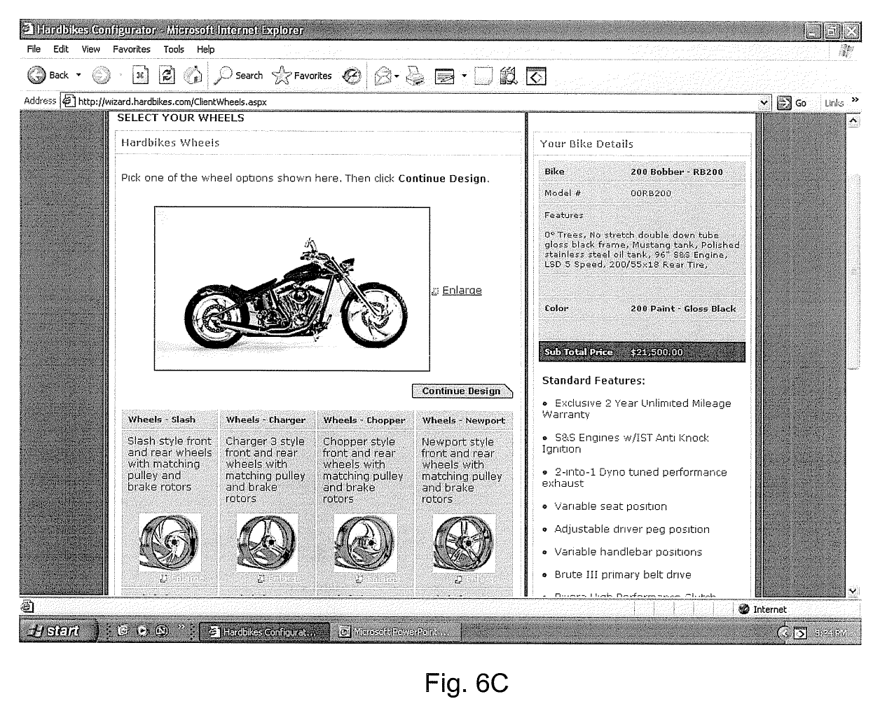

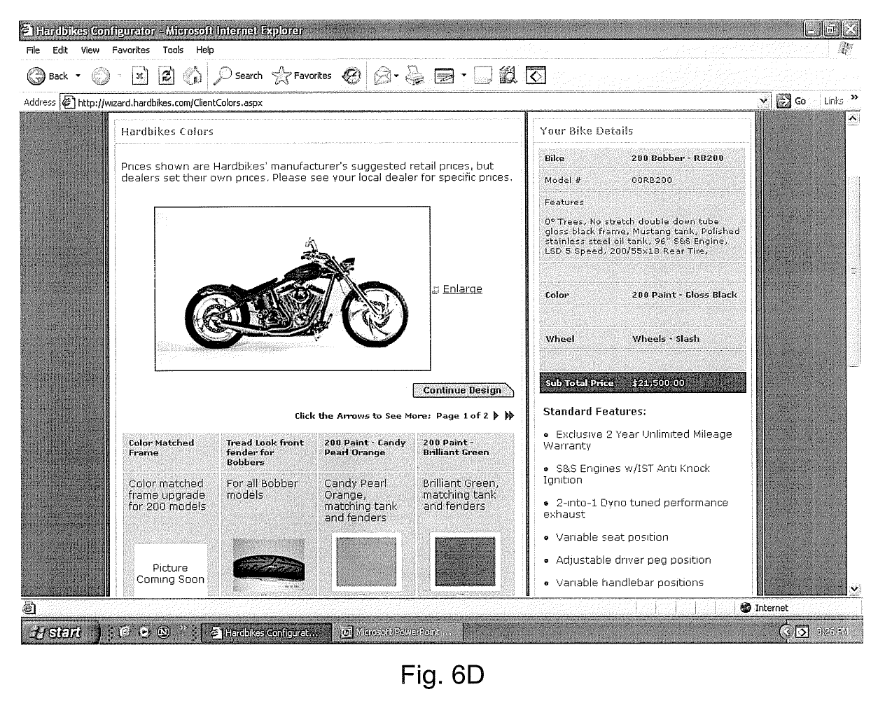

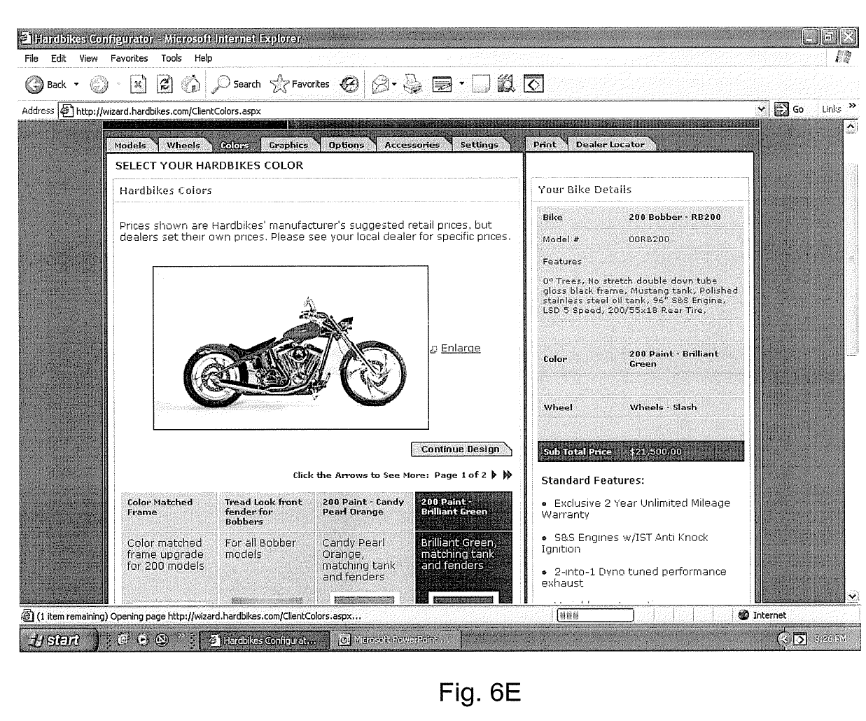

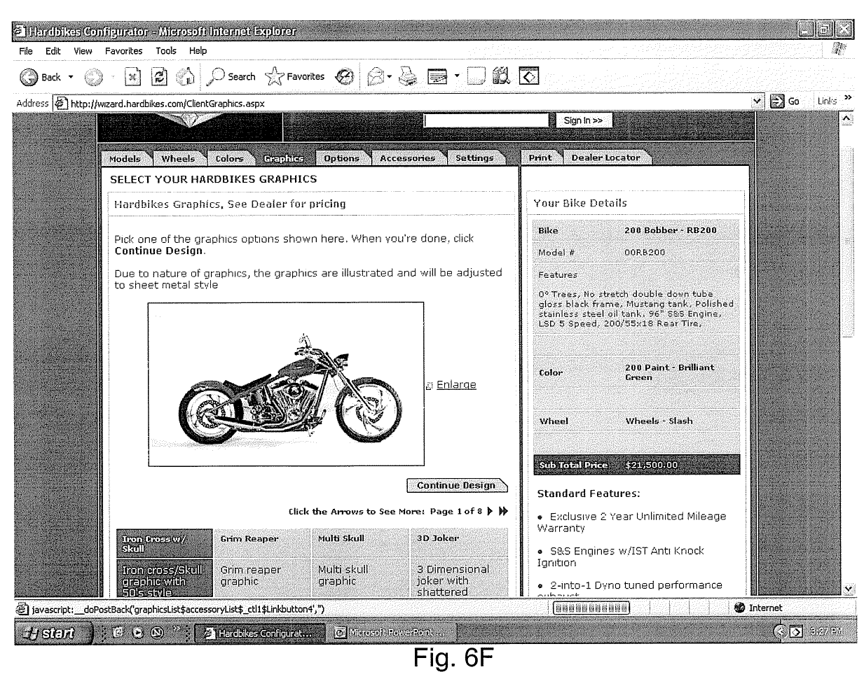

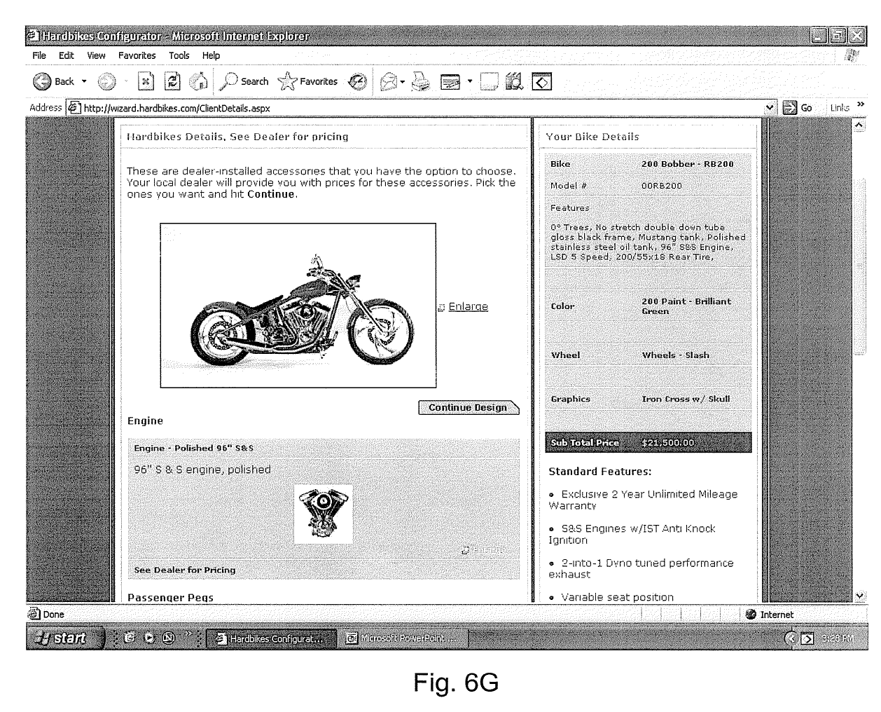

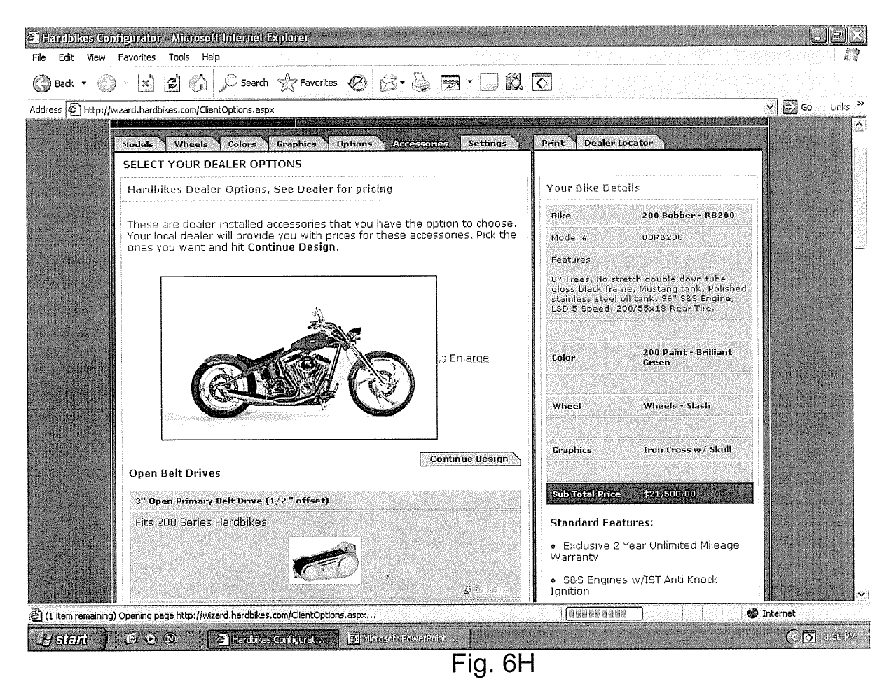

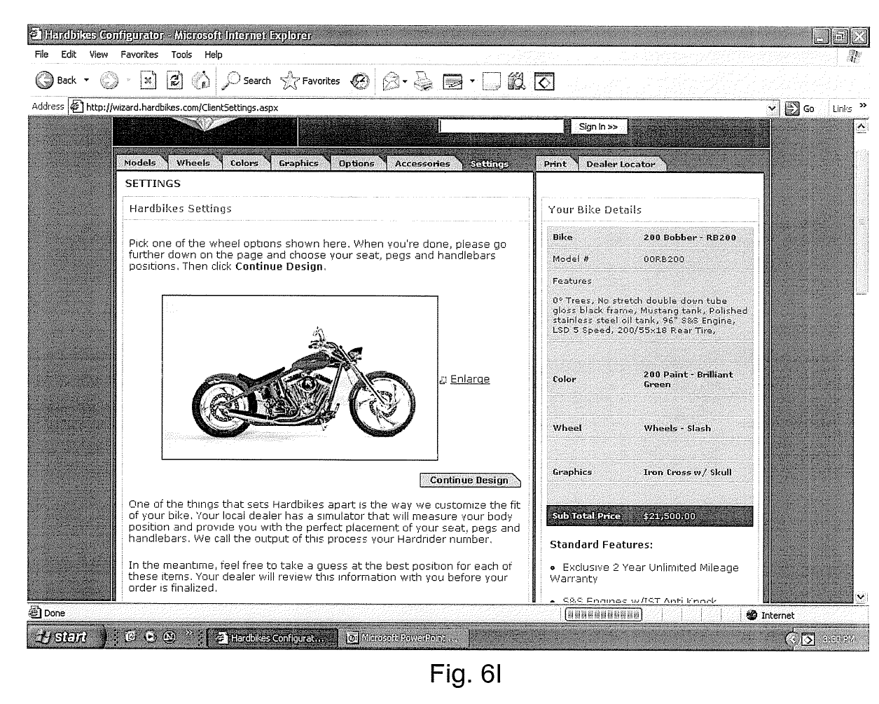

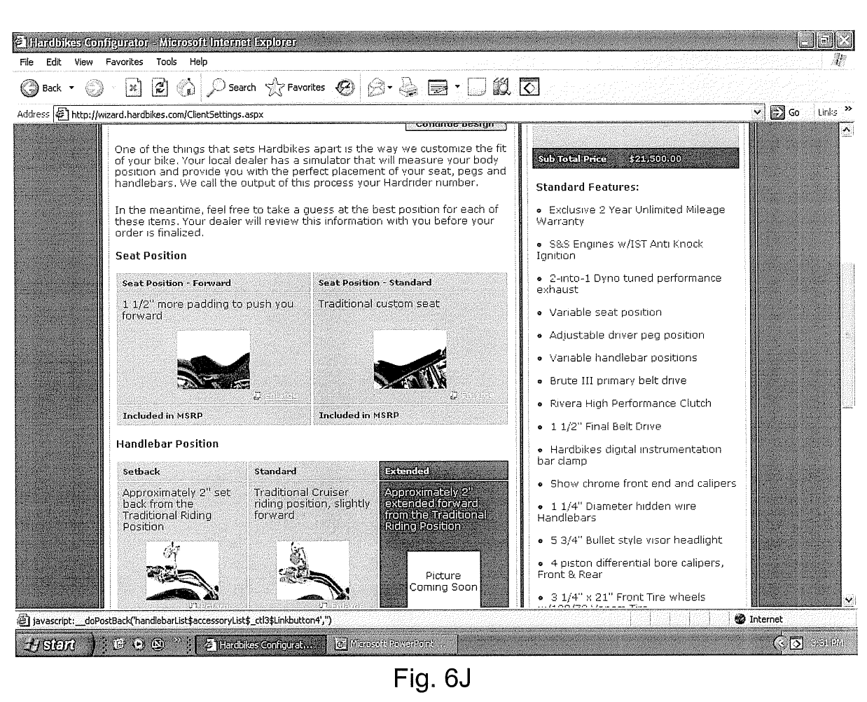

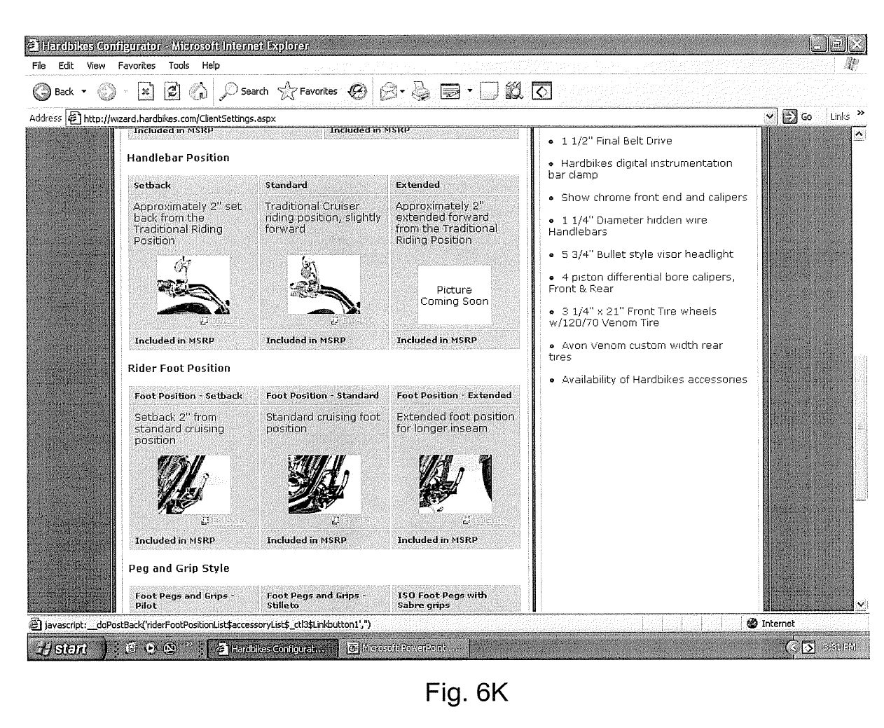

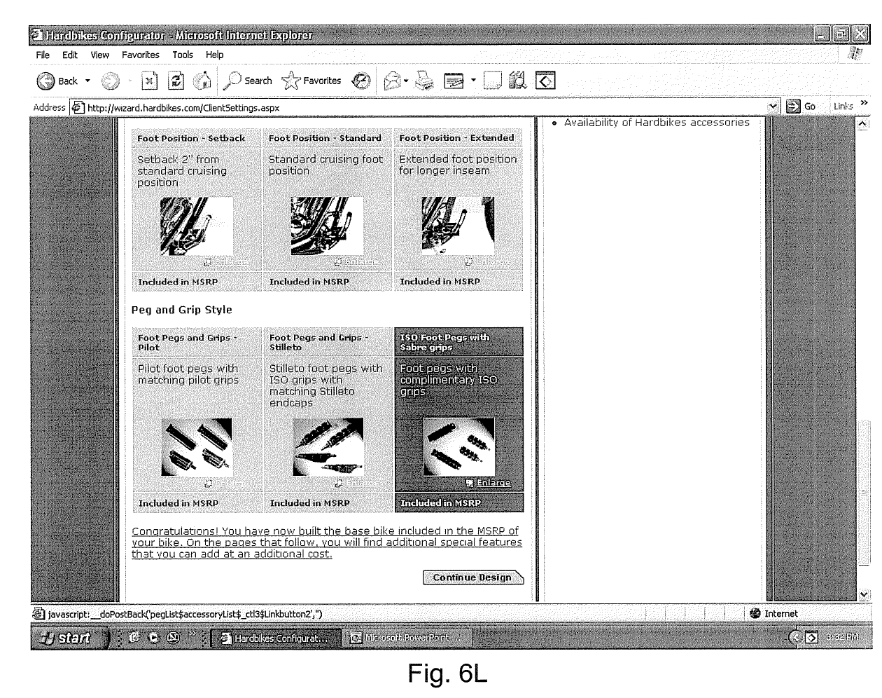

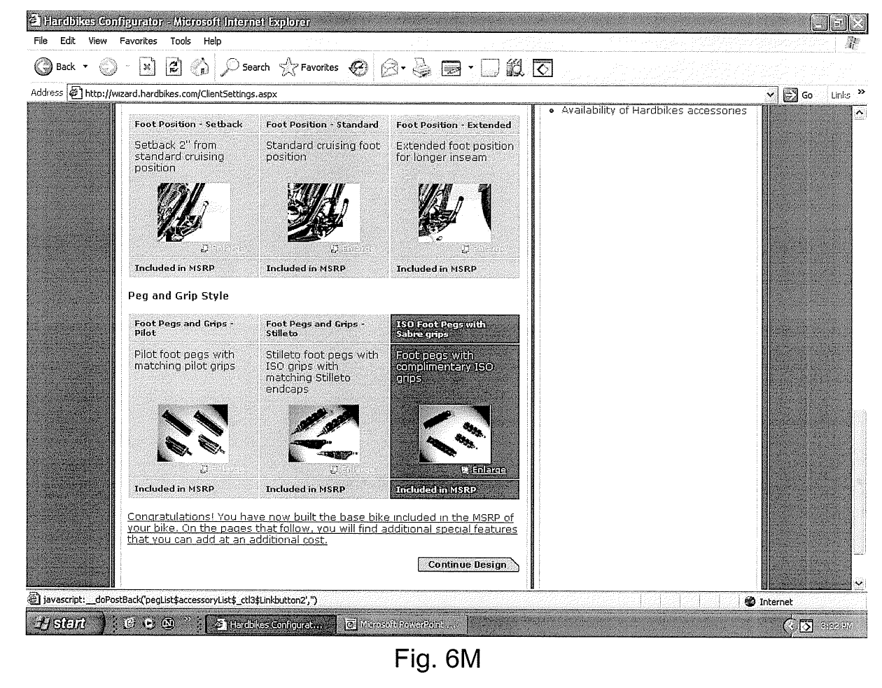

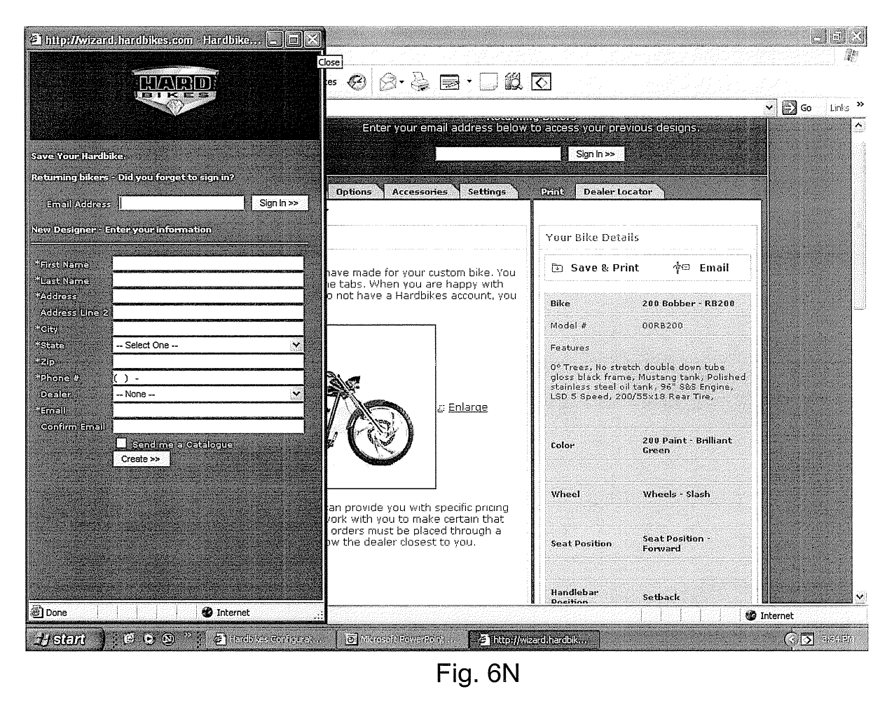

Optionally, rider 300 may preselect certain adjustable features of the customized bike prior to actually sitting on and using simulation tool 10. In an example, rider 300 may use an online preselection option, such as by clicking on a plurality of selections or choices provided on a series of WebPages. An example of a series of screenshots that rider 300 may use to make preselections is provided in FIGS. 6A-6N. In the example shown, rider 300 is instructed that the method of designing the customized the bike may begin with the step of making at least one preselection and then visiting a bike dealer, for example, to finalize the selections by using the simulation tool 10. See FIG. 6A.

The next step in the optional preselection process is for the rider 300 to choose one of a plurality of models of bikes as a starting point for the customized bike. In examples, rider 300 is provided with base price information, standard features, model number, and/or a picture or photograph of an example of the each model. In an example, rider 300 preselects a model by clicking on a photograph of the selected model and then continuing to the next page. See FIG. 6B.

The next step in the optional preselection process is for the rider to preselect at least one adjustable feature. For example, rider 300 may be presented with a plurality of wheel designs, choices, or selections. Information provided to rider 300 about each selection may include a verbal description, a photograph, and/or pricing information, for examples. Rider 300 is asked to select one wheel design and to then continue to the next page. See FIG. 6C. In the example shown, similar screens are provided to enable rider 300 to preselect colors (FIG. 6D, 6E), graphics (FIG. 6F), accessories such as engine and foot pegs (FIG. 6C), and options such as belt drives (FIG. 6H). In the example shown, at each step of the preselection process, rider 300 can track the details of the preselections already made by referring to the “Bike Details” for information on the preselections made, standard features provided, and pricing. See FIGS. 6B-6H.

In the example shown, in the next step of the preselection process, rider 300 is prompted to choose positions of seat i.e., seat means 85), foot pegs 70, and handlebars (i.e., steering means 80), to allow the rider 300 to estimate the optimal position for each of these features. Preferably, rider's selections will be reviewed by a dealer, manufacturer, or the like prior to the customized bike being built in order to determine the “comfort triangle” described above. See FIGS. 6I-6M.

In a final step in the preselection process, rider 300 is provided with a summary of the preselections made and is then prompted to provide contact information to submit the preselection order form for review. See FIG. 6N. Preferably, the preselections will be compared to a predetermined set of adjustments for each adjustable feature based on the rider's biomechanical measurements and other factors to create a customized bike that is optimally comfortable for rider 300, such as one that is defined by the rider's “comfort triangle.” In an example, rider's 300 preferred riding position is electronically transferred to a designer who uses at least the comfort triangle and rider's 300 selections, to overlap the rider's look onto the selected bike. The rider will be able to use the simulation tool 10 as described above to simulate a bike having the features adjusted and to optionally further adjust these and/or an additional adjustable features.

In an embodiment, the present invention is a method of selling to the public a customized bike using the simulation tool 10. The method of selling comprises the step of having a customer input data relating to modelable aspects of a bike into a configurator 150 which provides a graphic display of a bike configurable by a touch screen, for example, to build a bike of the customer's selection. Only compatible parts are selectable by the customer. A database 151 is accessible through configurator 150 and contains all possible selections which can be used to make a bike, including modelable aspects of the bike. For example, these modelable aspects may include, but are not limited to, color of exterior paint, style of wheels, handlebars, or foot pegs, engine size, and chrome choices. The variations in modelable aspects available are provided on the screen configurator 150 and allow the customer to see the finished configuration of at least the physical parameters of the bike before the bike is manufactured. After the customer selects a bike preference, the configurator sends data relating to the frame's 20 physical components to computer-aided design 152 which imparts its output specification to the simulation tool 10. The method includes simulating the configuration preferred by the customer using the simulation tool 10, whereby the customer is positioned on a simulation tool 10 having a frame 20 with the customer's selected physical components. Optionally, the customer may modify the configuration based on the simulation sent by CAD 152. The simulation tool 10 is iteratively connected to the configurator 150 so that these modifications or adjustments may be made. The simulation that meets the customer's expectations is then outputted to an input system that creates a build specification for production of the modeled bike. This build specification is sent to the factory and a customized bike is manufactured.

While the foregoing has been set forth in considerable detail, it is to be understood that the drawings, detailed embodiments, and examples are presented for elucidation and not limitation. Design variations, especially in matters of shape, size, and arrangements of parts, may be made but are within the principles of the invention. Those skilled in the art will realize that such changes or modifications of the invention or combinations of elements, variations, equivalents, or improvements therein are still within the scope of the invention as defined in the appended claims. In particular, one skilled in the art will understand that there are basic differences between the design parameters of a motorcycle and a bicycle and thus will know not to use or modify a bicycle to replicate the look of the “chopper” style motorcycle for use as a race bike.

What is claimed is:

1. A simulation tool, comprising:
(a) a frame that simulates at least one structural component of a bike, said frame including a first and a second wheel simulation point, said frame having a first adjustable vertical member for positioning a seat means, a second adjustable vertical member for adjustably securing a steering means, a first adjustable fork member connected to said second vertical member and operatably related to said steering means and simulating control at a first wheel simulation point, a first adjustable longitudinal member positioned between said first adjustable vertical member and said first adjustable fork member, and at least one pair of adjustable foot pegs or pedal; and
(b) a means for imparting a controllable simulation of ride characteristics to said frame.

2. A simulation tool according to claim 1 further comprising an engine support means for a motorcycle.

3. A simulation tool according to claim 1 wherein said ride characteristics are at least one of vibration, harmonics, bounce, controllability, steerability, stiff to ride, or a combination thereof.

4. A simulation tool according to claim 1 wherein said simulation tool further comprises a means for imparting a simulation of a riding surface to said frame.

5. A simulation tool according to claim 1 or 4 wherein said means for imparting said simulation is a computer controlled network operably connected to said frame.

6. A simulation tool according to claim 1 further comprising a means for capturing an image of a rider.

7. A simulation tool according to claim 1 further comprising a monitor.

8. A simulation tool according to claim 1 wherein said frame is a motorcycle frame.

9. A simulation tool according to claim 1 wherein said frame is a bicycle frame.

10. A simulation tool according to claim 4 wherein said simulation of said riding surface simulates at least one of the following:
a. asphalt;
b. concrete;
c. pavement;
d. dirt;
e. rock;
f. grass;
g. mud;
h. weeds;
i. bumps on said surface;
j. or a combination thereof.

11. A simulation tool according to claim 1 wherein said steering means is a handlebar having a solid or a hollow shaped rod.

12. A simulation tool according to claim 1 wherein said frame further includes at least one pair of adjustably removable shock absorbers positioned between said fork and frame and said other of said pair positioned between said first vertical member and said seat means.

13. A simulation tool according to claim 1 wherein said frame is made from at least one of the following:
a. aluminum;
b. steel;
c. fiberglass;
d. titanium; or
e. a combination thereof.

14. A simulation tool according to claim 1 wherein said tool simulates a motorcycle.

15. A simulation tool according to claim 1 wherein said frame further comprises at least one of a first grab means, a support means attached to said frame for providing support to a body of said passenger, a second adjustable seat means, and at least one second pair of adjustable foot pegs.

16. A simulation tool according to claim 1 further including a computer controlled means for measuring or calculating from a fixed point any adjustments made to said frame to provide an output for design or manufacture of a custom bike.

17. A method of using the simulation tool of claim 1 or 15 to create a specification related to a body of a rider, said specification being based on a simulation, said method comprising at least one of the following steps:
a. collecting and recording at least one biomechanical measurement of said rider;
b. selecting said simulation tool;
c. adjusting said simulation tool to a first suggested position;
d. positioning said rider on said simulation tool;
e. activating said simulation tool to simulate said ride characteristic of said frame;
f. optionally further adjusting said simulation tool;
g. selecting said rider's preferred riding position of said simulation tool; and
h. combining said at least one biomechanical measurement of said rider and said rider's preferred riding position to create said specification;
wherein steps a through f may be performed in any order and may be repeated at least twice.

18. A method according to claim 17 further comprising the step of preselecting at least one of said adjustable features is prior to said simulation.

19. A method according to claim 18 wherein said preselections include a position of seat means, steering means, and/or foot pegs.

20. A method according to claim 17 further comprising the step of evaluating said selections for compliance with a predetermined set of adjustments.

21. A method according to claim 19 further comprising the step of evaluating said preselections for compliance with a predetermined set of adjustments.

22. A method according to claim 17 further comprising at least one of the following steps:
a. collecting and recording at least one biomechanical measurement of at least one passenger;
b. adjusting said simulation tool to a second suggested position;
c. positioning said at least one passenger on said simulation tool;
d. optionally further adjusting said simulation tool;
e. selecting said at least one passenger's preferred riding position of said simulation tool based on said simulation;
f. including said biomechanical measurements of said at least one passenger in said creation of said specification.

23. A method according to claim 17 or 22 further comprising the step of using said specification to manufacture or sell at least one of the following:
a. a customized bike;
b. at least one accessory; or
c. a combination thereof.

24. A method of claim 23 further comprising the step of including at least one passenger in said simulation at any time after said manufacture or sale of said customized bike.

25. A method of claim 23 further comprising the step of making at least one further adjustment at any time after said manufacture or sale of said customized bike.

26. A method according to claim 17 or 22 wherein said adjustments are three-dimensional relative to a predetermined point of origin.

27. A method according to claim 17 or 22 wherein said adjustments are infinitely variable between a first and a second endpoint.

28. A method according to claim 17 or 22 wherein said adjustments are adjustable to at least one discrete point.

29. A method according to claim 17 or 22 wherein said specification is created by a computer program.

30. A method according to claim 17 or 22 further comprising the step of choosing a riding surface.

31. A method according to claim 30 further comprising the step of changing said riding surface.

32. A method according to claim 17 wherein said collection and recording of said at least one biomechanical measurement of said rider comprises a collection of at least one physical measurement of a body of said rider.

33. A method according to claim 22 wherein said collection and recording of said at least one biomechanical measurement of said at least one passenger comprises a collection of at least one physical measurement of a body of said passenger.

34. A method according to claim 32 or 33 wherein said at least one physical measurement is at least one of the following:
a. height;
b. weight;
c. length of arms;
d. length of legs;
e. foot size;
f. arm strength;
g. leg strength;
h. hand strength;
i. or a combination thereof.

35. A method according of claim 17 further comprising the step of collecting a plurality of biographical data about said rider.

36. A method claim 35 wherein said biographical data include at least one of:
a. at least one hobby of said rider;
b. a profession of said rider;
c. at least one interest of said rider;
d. or a combination thereof.

37. A method according to claim 35 further comprising the step of using said biographical data to select at least one cosmetic feature of said customized vehicle.

38. A method according to claim 37 wherein said at least one cosmetic feature is artwork.

39. A method according to claim 38 wherein said artwork is applied to an exterior of said customized vehicle.

40. A method of selling to the public a customized bike using the simulation tool of claim 1 and comprising the steps of:
a. having a customer input data relating to modelable aspects of a bike to present a finished configuration outputting at least physical parameters of said bike to a computer simulation;
b. simulating said configuration with said customer using said simulation tool to simulate said ride characteristics of said modeled bike; and
c. outputting said simulation to an input system for specifying a build specification for production of said modeled bike.

41. The method of claim 40 further comprising the step of modifying said configuration based on said simulation.
